(19) United States
(12) Patent Application Publication
(10) Pub. No.: US 2005/0195292 A1
(43) Pub. Date: Sep. 8, 2005

(54) System and method for providing a customized imaging product or service

(75) Inventors: Dale F. Mclntyre, Honeoye Falls, NY (US); Joseph A. Manico, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/792,531

(22) Filed: Mar. 3, 2004

(51) Int. Cl. H04N 5/76; G06F 17/60; H04N 5/232

(52) U.S. Cl. 348/231.6; 348/211.3; 705/16

(57) ABSTRACT

A system and method for providing a high value customized imaging device. The method includes providing the imaging product; receiving custom information; modifying the imaging product using the custom information to generate a customized imaging product; testing the customized imaging product; dispensing the customized imaging product; receiving the customized imaging product; identifying the customized imaging product; verifying the operability of the identified customized imaging product; and associating the custom information with the customized imaging product to provide the imaging service.

### CROSS REFERENCE TO RELATED APPLICATIONS

Reference is made to commonly assigned application U.S. Ser. No. 10/163,539 (Kodak Docket No. 84521), entitled “SYSTEM AND METHOD FOR PROVIDING A CUSTOMIZED IMAGING PRODUCT OR SERVICE”, filed on Jun. 6, 2002 in the names of J. A. Manico et al., and which is assigned to the assignee of this application.

### FIELD OF THE INVENTION

The invention relates generally to the field of photography and film units. More particularly, the present invention relates to the automated vending of customized photographic products and services having a relatively high dollar/cost value for a one-time use fee.

### BACKGROUND OF THE INVENTION

Vending kiosks, sometimes referred to as vending machines or vending systems, are well known for the automated dispensing of a product. Vending kiosks can operate autonomously and accept cash payment or payment by means of a credit/debit card. Such vending kiosks can also provide a service, for example the Kodak Picture Maker kiosk provides prints and enlargements of images.

Various products can be dispensed from a vending kiosk, including photographic products such as photographic film or a single-use camera. However, such products are typically those are relatively low cost products. For example, high-end electronics products such as digital cameras and video camcorders are not dispensed from vending kiosks. Yet, there may be situations wherein a user may want to use/rent such a high-end product for a limited period of time. For example, a user may be on vacation and want a digital camera to capture memories of a special event.

Accordingly, there exists a need for a vending kiosk which can dispense/distribute customized products having a relatively high dollar/cost value to a user for a predetermined period of time.

### SUMMARY OF THE INVENTION

An object of the present invention is to provide a system and method of producing a customized high value imaging product for a user for a predetermined/limited period of time.

Another object of the present invention is to provide a method of accepting a returning customized high value imaging product from a user and validating the operational integrity of the returned device.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a system for providing a high value customized imaging device. The system comprises input means for providing custom information; means for customizing a high value imaging device to generate the high value customized imaging device in accordance with the custom information; a test section for validating the readiness for use of the high value customized imaging device; a means for securing agreement to the terms of use of the high value customized imaging device; and a delivery section for dispensing the high value customized imaging device.

According to another aspect of the invention, there is provided a method for providing a high value customized imaging device. The method includes providing the imaging product; receiving custom information; modifying the imaging product using the custom information to generate a customized imaging product; testing the customized imaging product; dispensing the customized imaging product; receiving the customized imaging product; identifying the customized imaging product; verifying the operability of the identified customized imaging product; and associating the custom information with the customized imaging product to provide the imaging service.

### BRIEF DESCRIPTION OF THE DRAWINGS

The foregoing and other objects, features, and advantages of the invention will be apparent from the following more particular description of the preferred embodiments of the invention, as illustrated in the accompanying drawings.

FIG. 1 shows a schematic view of an embodiment of a digital camera having a radio-frequency identification transponder with the position of the transponder being indicated by dashed lines.

FIG. 2 shows a schematic view illustrating use of the transponder in the digital camera of FIG. 1.

FIG. 3 shows a front view of a kiosk in accordance with the present invention.

FIG. 4 shows a cross-sectional view of a kiosk to show the interior of the kiosk in accordance with the present invention.

FIGS. 5(a)-(e) show a digital camera being customized and tested in the customization area of the kiosk.

FIG. 6 shows a flow diagram of a first method in accordance with the present invention for providing a high value imaging product.

FIGS. 7(a) and (b) show the kiosk in communication with a remote location by means of a communication network or wireless communication, respectively.

FIG. 8 shows the kiosk of FIG. 3 having a receiving area for receiving a returned high value imaging product.

FIG. 9 shows the kiosk of FIG. 3 having a returned digital camera quality validation check station.

FIGS. 10(a)-(h) show a returned high value camera being received by the kiosk and.

FIG. 11 shows a flow diagram of a second method in accordance with the present invention for providing a high value imaging product.

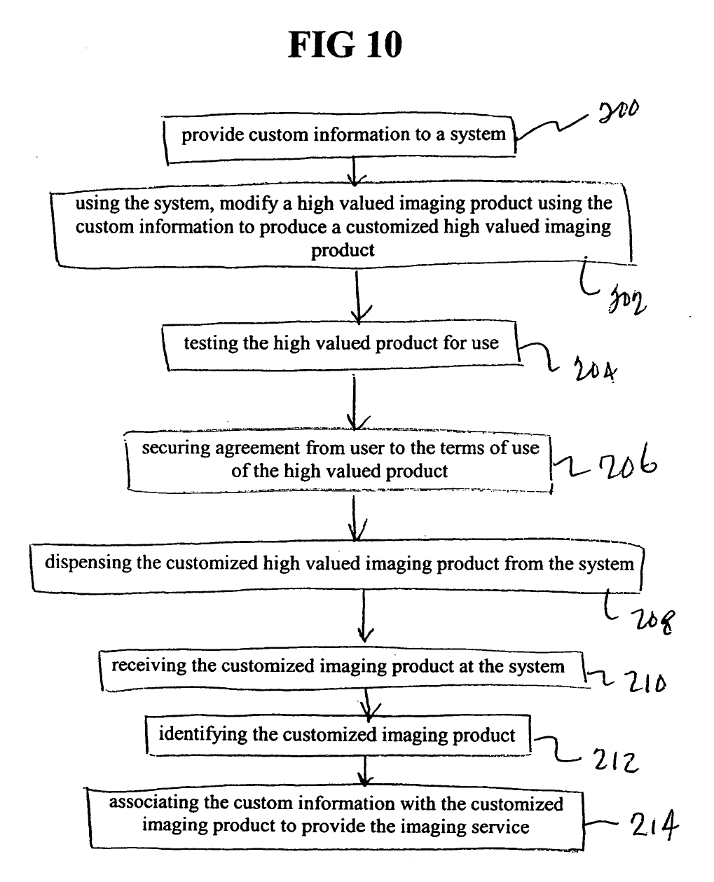

### DETAILED DESCRIPTION OF THE INVENTION

The following is a detailed description of the preferred embodiments of the invention, reference being made to the drawings in which the same reference numerals identify the same elements of structure in each of the several figures.

The present invention provides a system and method of providing an imaging device/product that has a relatively high dollar value for a predetermined time period. That is, the cost of the imaging product being supplied is greater than the fee being charged for the use of the imaging product. In addition, the fee being charged for the use of the imaging is limited to the use of the imaging device for a predetermined time period and the safe return of the imaging device. The fee can optionally include particular services that are customized to the imaging device to be performed upon the return of the imaging device. As such, this might be viewed to be a rental or loan of the high valued device.

The present invention employs a radio-frequency identification transponder disposed within the imaging product wherein the transponder is programmed with customized information. Examples of imaging products include digital cameras, video cameras, video camcorders, and the like.

Radio-frequency (RF) identification transponders are well known and are available in a variety of forms. These RF transponders include a non-volatile memory, such as an EEPROM (electrically erasable programmable read-only memory) semiconductor component integrally contained in the transponder. Stored in the non-volatile memory are encoded data. Inlay transponder are identification transponders that have a substantially flat shape. The antenna for an inlay transponder is in the form of a conductive layer deposited on a non-conductive support. The antenna has the shape of a flat coil or the like. Leads for the antenna are also deposited, with non-conductive layers interposed as needed. Memory and any control functions are provided by a chip mounted on the support and operatively connected through the leads to the antenna. Inlay transponders have been used as layers on identification tags and labels to provide encodements that are accessible at a distance.

U.S. Pat. No. 6,173,119 (Manico), commonly assigned and incorporated herein by reference, relates to a camera having a radio-frequency identification transponder.

U.S. Pat. No. 6,381,416 (Manico), commonly assigned and incorporated herein by reference, discloses a film unit having an image capture media and a radio-frequency identification transponder affixed to the image capture media. The image capture media can be photographic film.

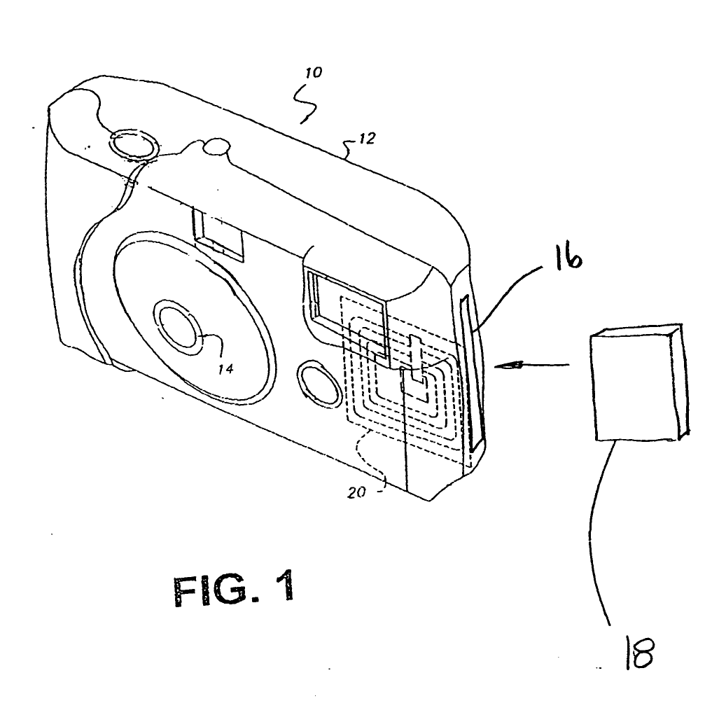

Referring to FIG. 1, there is shown an imaging device 10 which is a high valued imaging device which is customized in accordance with the present invention. For discussions purposes only, imaging device 10 is shown configured as a digital camera. Examples of other high valued imaging devices, which can be customized in accordance with the present invention, can include video camcorders, cellular telephones including image capture means, and the like.

As illustrated, imaging device 10 includes a body 12, a lens 14, and an opening/aperture adapted to receive a memory device 18 such as a memory card, memory stick, SD card, floppy, CD, or the like. Digital cameras are well known devices adapted to capture digital images and/or motion images in a manner well known to those skilled in the art, an example of which is the Kodak DX3600 Easy Share Digital Camera manufactured by Eastman Kodak Company.

Imaging device 10 further includes a radio-frequency (RF) identification transponder 20. As illustrated in FIG. 1, transponder 20 is disposed within body 12. However, transponder 20 can be located/disposed in a plurality of location within or on imaging device 10 though preferably transponder 20 is located within body 12. For example, transponder 20 can be disposed on memory device 18, either within memory device 18 or on an external surface of memory device 18. Still further, imaging device 10 can comprise a plurality of transponders. For example, a first transponder 20 can be disposed within/on body 12 while a second transponder 20 can be disposed/within memory device 18. Alternatively, body 12 can include the plurality of transponders 20. The first and second transponders can store the same or different encodements, and be independently or commonly accessible by a radio frequency.

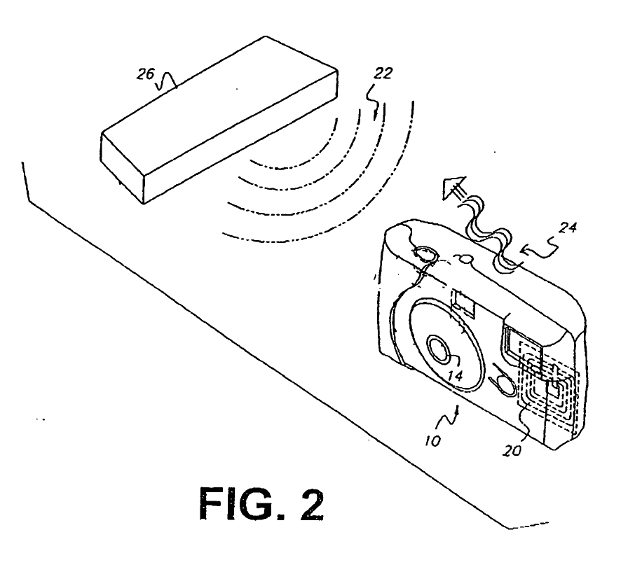

The term “radio-frequency identification transponder” is used herein to refer to any of a class of compact radio receiver-transmitters which are powered by an ambient radio-frequency field as indicated by line pattern 22 in FIG. 2. Generally, transponder 20 is accessed by modulating the field 22 with an appropriate communication signal. The transponder 20 reacts (indicated by arrow 24 in FIG. 2), responsive to the communication signal. The communication signal 22 is generated and the encodement is detected by a communication unit or transceiver 26. It is noted that in order to access from or provide information to transponder 20, no physical contact with the read/write device is required. Other systems which require physical contact are prone to wear, such as the electrical contact points, or require physical securement to these points. Further, because of the physical contact requirement, the shape/design of a product incorporating a memory device requires that the contact portion be accessible to the read/write device.

A dispensing unit, such as a kiosk or vending system, is provided to supply imaging device 10 and dispense the high valued imaging device to user. Prior to dispensing to the user, the kiosk customizes the imaging device for the user. That is, transponder 20 is customized by being programmed with information specific to the user. As such, the present invention relates to a system for providing a customized high value imaging device. Such dispensing units are intended to operate autonomously, and can be a free standing unit located at a retail or non-retail location, or a unit located as a component of architecture (such as mounted within a wall). A user can interact with the dispensing unit either in an indoor and/or outdoor environment, and either walk-up or drive-through.

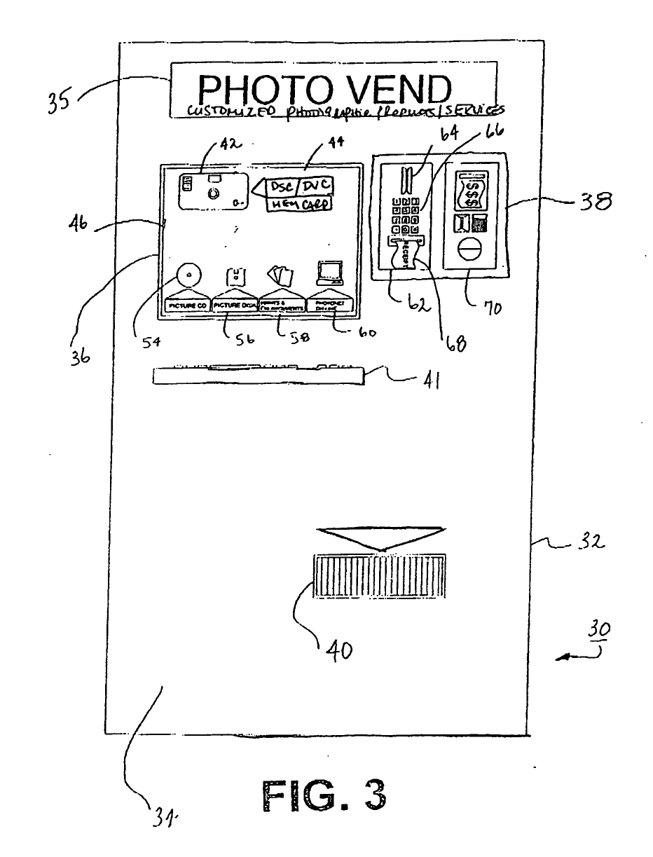

An exemplary dispensing unit is generally illustrated in FIG. 3 as kiosk 30 adapted for individually dispensing a plurality of imaging devices 10. As noted above, for ease of discussion, imaging device 10 is configured as a digital camera though it is recognized that one or more imaging products can be dispensed from kiosk 30.

As illustrated in FIG. 3, kiosk 30 includes a body 32 having a display side 34 providing an interface with the user/operator/purchaser/customer of imaging device 10 dispensed from kiosk 30. The interface includes an input device/means for obtaining information from the user as well as providing information or instructions to the user. As illustrated in FIG. 3, the input means of display side 34 comprises a monitor or display 35, a selection area 36 defining imaging device feature, a payment area 38, a delivery area 40, and an input device 41.

Display 35 provides an area for displaying information to the user, such as instructions or advertisements or the like, to communicate with the user. As illustrated in FIG. 3, display 35 is displaying an advertisement for kiosk 30. Display 35 can be used, upon dispensing imaging device 10, to display a target image capture by the camera to validate its readiness for use. The target image captured by the camera can include an image of the user/purchaser for identification and security purposes. In addition, display 35 can be used interactively upon return of imaging device 10 to provide selective services based on the images transferred from imaging device 10 to display 35. For example, the user may wish to select different quantities of prints to be made from different exposures captured by imaging device 10.

Selection area 36 displays products and/or services from which the user can select. Icons, text, symbols, images, or other graphical indicators can be used to represent the products/services. For example, as illustrated in FIG. 3, an icon 42 of a digital camera is displayed along with textual information 44 of digital camera features which can be selected (e.g., type of memory card, digital still image capture, motion image capture, and the like). Similarly, icon 54 represents a Picture CD (i.e., a CD) product, icon 56 represents a Picture Disk (i.e., a floppy disk) product, icon 58 represents a service of prints/enlargements, while icon 60 represents Ofoto, Inc., a Kodak company which provides a service wherein images are stored digitally on a server which can be accessed by means of the internet. Other imaging products and/or services can be similarly represented in selection area 36, including memory size for memory device 18, memory type, digital resolution, water resistance feature, output format, image print type/size, image storage device type including on-line storage or disc storage, print modification, annotation, borders, graphics, designated recipient, delivery location and address, generation of software or hardware albums, payment means including debit card, credit card, later billing, and the like.

The user can communicate with selection area 36 by means of an RF-enabled tag. For example, the user can employ a “loyalty card” comprising an RF tag wherein the RF tag is encoded with user information and preferences, for example, name, address, a preference for 4×6 prints, and/or a preference for an index print. Accordingly, if selection area 36 includes an RF reader, the encoded information can be read/transferred to kiosk 30. Alternatively, such a loyalty card can comprise magnetically encoded information or electrically stored information.

Payment area 38 includes one or more payment mechanisms for accepting payment from the user. One payment mechanism illustrated in FIG. 3 is a card reader 62 which includes a slot 64 for accepting a credit card or a keypad 66 for entering a credit card number. A receipt area 68 can be provided for providing a receipt to the user. Because the value of imaging device 10 exceeds the charge/fee for its use, the credit card information is retained/stored along with the custom information, the product description including the serial number of the imaging device dispensed to the user, and/or other information/identification included in the encoded transponder 20 and the expiration/end date of the intended use. Display 35 can be used to notify the user/purchaser that completing the transaction constitutes an agreement to return imaging device 10 in good working order/condition or the user/purchaser will be charged for the full value of the imaging device. Optionally, the expiration date may be a trigger/reminder to bill the user/purchaser for the full value of the imaging device (as compared to a one-time use charge). Still further, kiosk 30 can allow the user/purchaser to take insurance on the imaging device.

Another payment mechanism illustrated in FIG. 3 is an alternate payment mechanism 70 configured to accept cash payment or any other form or acceptable payment. In one arrangement, a user can provide a cash deposit refundable upon acceptable return of the dispensed imaging device. In another arrangement, a bar-coded or RF-enabled keychain fob (also referred to as a key tag; the MOBIL SPEEDPASS is an example of a RF-enabled key tag).

Delivery area 40 provides a means for delivering the customized high-value imaging device to the user. As shown in FIG. 3, delivery area 40 is configured as an opening in display side 34 for accessing the high value customized imaging device, though other configurations may be known to those skilled in the art.

Input device 41 can comprise a keyboard, as shown in FIG. 3, or other input means known to those skilled in the art. For example, display 35 could be employed as an input device if configured as a touchscreen. Other suitable input devices can include a card reader, radio-frequency reader, retinal scan, facial recognition, and a telecommunication device. Input device 41 is employed to obtain information from the user, information such as the user's name, address, telephone number, or account number in the event that they user has an existing relationship with a photoservice provider. Input device 41 can be used to communicate with selection area 36.

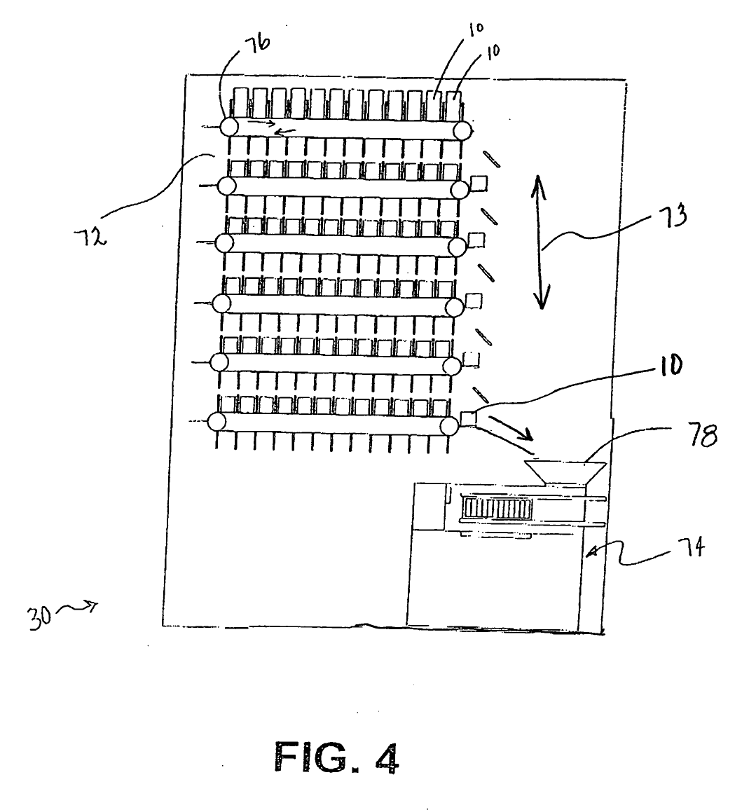

FIG. 4 shows a cross-sectional view of kiosk 30 illustrating an exemplary interior of the kiosk. A plurality of cameras 10 are disposed within kiosk 30 in a product area 72 supporting a supply of imaging products (i.e., as shown in FIG. 4, digital cameras). For the arrangement shown in FIG. 4, imaging device 10 is moved, one at a time, from product area 72 to customization area 74 upon activation of kiosk 30, i.e. a user providing payment and making an imaging product selection. For other arrangements known to those skilled in the art, more than one imaging device 10 can be moved simultaneously. Those skilled in the art will also recognize that various means/methods can be used to move imaging device 10 from product area 72 to customization area 74. One method, illustrated in FIG. 4, employs a movable conveyance illustrated as a conveyor 76 which is incremented a predetermined amount in a horizontal direction to move one camera 10 from product area 72 to customization area 74. It may be preferred that imaging device 10 not be dropped a distance, so further conveyor means can be employed to move product area 72 in a vertical direction, as shown by arrow 73, proximate customization area 74. For example, means such as a slide can cause one imaging device 10 to leave the conveyor and drop through an opening, shown as a hopper 78, to enter customization area 74.

The specific imaging device 10 selected for movement to customization area 74 can be dependent on the selections made by the user at selection area 36. For example, if the user selected an imaging device with motion recording capabilities, an imaging device with that feature will be moved to customization area 74. Similarly, if the user selected an imaging device with a particular memory card, the imaging device with that feature will be moved to customization area 74.

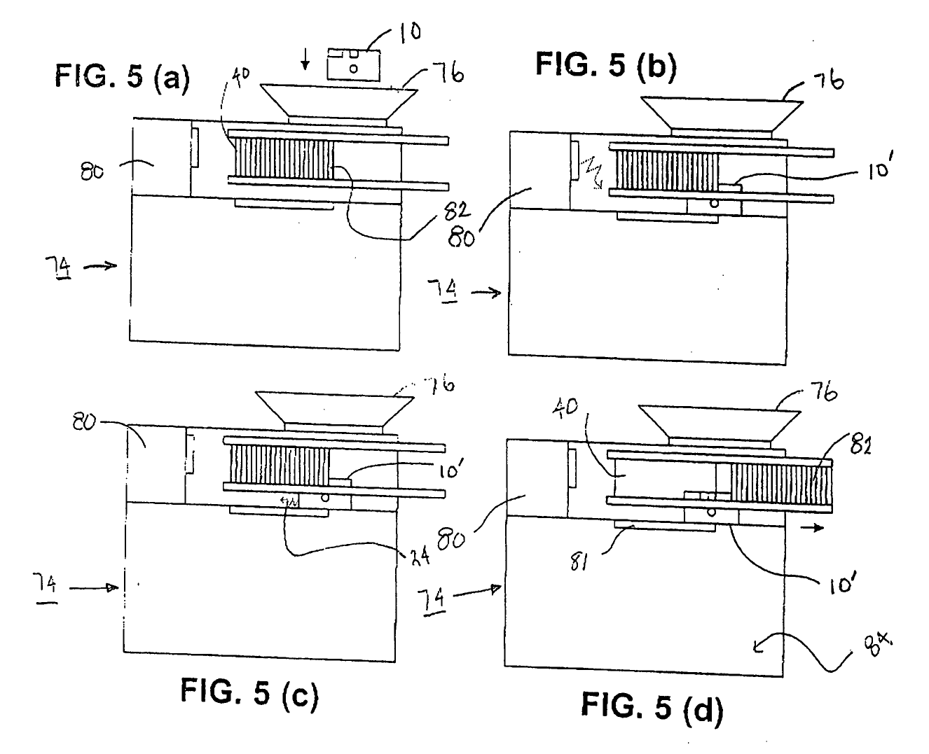

Referring now to FIG. 5(a)-5(d), customization area 74 provides means for customizing the imaging device/product (i.e., digital camera 10) to generate the customized imaging product. Means for customizing digital camera 10 comprises a radio frequency communication device 80 for encoding an encodement(s) in transponder 20. Radio frequency communication device 80 comprises transceiver 26 and is adapted to work collaboratively with other components of kiosk 30 and will be described in more detail below.

FIG. 5(a) shows digital camera 10 entering customization area 74 through hopper 76. Customization area 74 can include means (not shown) for detecting the presence/absence of digital camera 10, such as an IR detector or pressure sensor or the like.

Referring now to FIG. 5(b), once at customization area 74, communication device 80 is activated to customize digital camera 10, whereby encodements specific to the user are encoded in transponder 20 to generate a customized imaging product, referred to as digital camera 10′. The encodements can include information relating to the user, imaging product, sale of the imaging product, or services related to the imaging product. For example, user information could include name/address/phone number or a designated recipient other than the user. Imaging product information can include camera serial number, date of manufacture, camera functions/features such as lens zoom, type of flash, and camera configuration including memory size, borders, and/or annotation. Acquisition information can include date, location, receipt information such as whether a receipt was provided to the user, and/or payment method. Services information can include the services that were purchased for the digital camera, including Picture CD, Picture Disk, print and enlargements, digital effects, enhancements and/or modifications (such as sharpening, color changes, custom text and graphics, artifact removal and the like) and/or upload to Ofoto, Inc. or other online service provider.

Once digital camera 10 is encoded to generate customized digital camera 10′, the encodements encoded in transponder 20 can be verified by determining if transponder 20 reacts to a verification signal sent by communication device 80. Transponder 20 reacts (indicated by arrow 24 in FIG. 5(c)), responsive to a communication signal generated and the encodement is detected by communication device 80 to determine if the information was properly encoded in transponder 20.

Customized digital camera 10′ can also be tested by kiosk 30 to validate its readiness for use. Such testing can occur within customization area 74. The testing can include using customized digital camera 10′ to capture a digital image of a test target disposed within customization area 74 and then analyzing the captured image. Such testing might require the need for some automated testing equipment within kiosk 30. Other tests to validate the readiness of customized digital camera 10′ may be known to those skilled in the art.

Other operations can be performed to prepare customized digital camera 10′ for the user. For example, the digital camera 10′ might be sanitized, shined, polished, or new labels/information might be applied. If it includes a rechargeable battery, the batter could be recharged.

Once encoded and verified, customized camera 10′ is presented to the user. In a preferred embodiment, customization area 74 is disposed adjacent to delivery area 40 as illustrated in FIGS. 5(a)-(d). As such, access to camera 10/10′ can be precluded until encodement and verification of transponder 20 has occurred. Access until then can be precluded by means/methods known to those skilled in the art, for example, a door or other covering 82. As illustrated in FIG. 5(a), covering 82 is disposed in front off delivery area 40, while in FIG. 5(d), covering 82 has been moved away from delivery area 40, thereby allowing access to customized camera 10′.

The user is now provided with an imaging product which has been customized to the user's specifications and validated for use.

An optional door/covering 81 can deliver a defective product to a holding area 84. Examples of defective products which would be delivered to holding area 84 include camera 10 having a non-operable or incorrectly operating transponder 20. Door/covering 81 can also be employed if the user does not remove camera 10′ from delivery section 40 within a predetermined time period.

Accordingly, the present invention provides a system for providing a customized imaging product. The system includes an imaging product; input means for providing custom information; means for customizing the imaging product to generate the customized imaging product; means for validating the readiness for its use, and a delivery section for dispensing the customized imaging product.

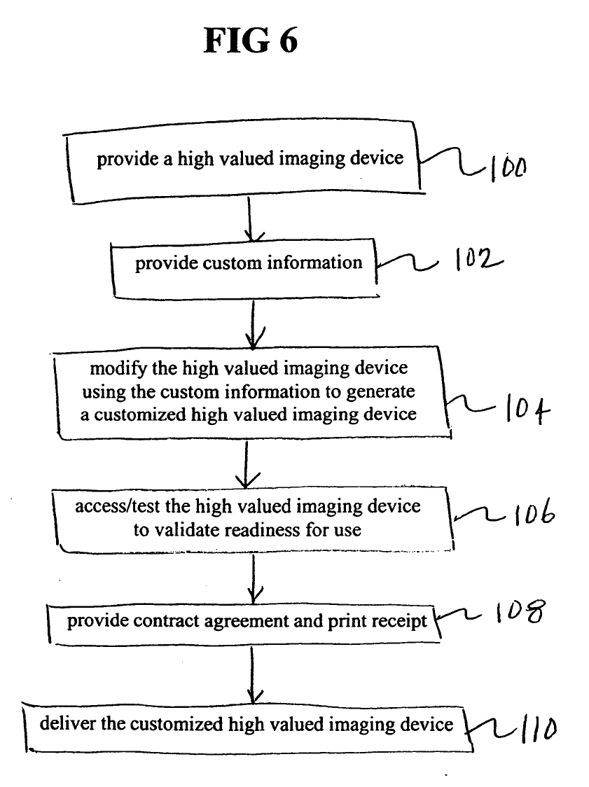

FIG. 6 provides a flow diagram of a method in accordance with the present invention for providing the customized high value imaging device disclosed above. At step 100, a high value imaging product is provided for selection by the user/purchaser as described earlier with respect to kiosk 30. Custom information is also provided (step 102) that can include the period of use governed by the agreement of step 108. The custom information is used to modify the high value imaging product to generate a customized high value imaging product (step 104) which is further tested by kiosk 30 (step 106) to validate its readiness for use. The purchaser is provided with an agreement (step 108) indicating the retention of the credit card data and the user's agreement for the use of the device, for example, to be charged full value in the event that the user doesn't return the selected high value imaging device. Such an agreement/terms can be displayed on display 35. A receipt of the agreement can be provided at the conclusion of the agreement step 108 after which the selected high value imaging device is delivered to a user (step 110).

The terms of the agreement can include the duration of the use of the customized digital camera. For example, there can be a fee for its daily usage or a flat fee for a predetermined time period (similar to a movie rental). The terms can also include a promise by the user to pay the full value of the digital camera if the camera is not returned in working order. By such arrangement, the use of the customized digital camera might be considered a loan or rental since the intent is to return the customized digital camera so as to not be charged for the full value of the digital camera. A copy of the agreement can be sent to the user using the user's email address, if that information is obtained from the user.

It may be desirable to transmit the custom information collected at step 102 to a remote location. For example, the payment information using a credit reader 62 can be transmitted so that payment can be verified/obtained and subsequently retained until the high value customized imaging device 10 is returned. Similarly, the custom information can be used to determine when kiosk 30 needs to be serviced or when kiosk 30 requires stocking of imaging products. Still further, custom information can be used to determine when a predetermined amount/quantity of imaging products have been received at kiosk 30 and collection or a repair is required. Yet further, it may be desirable to transmit the captured digital image of the test target to a remote or central location for a operator/technician to review the captured image to validate the operation of the customized digital camera prior to dispensing it to the user/purchaser.

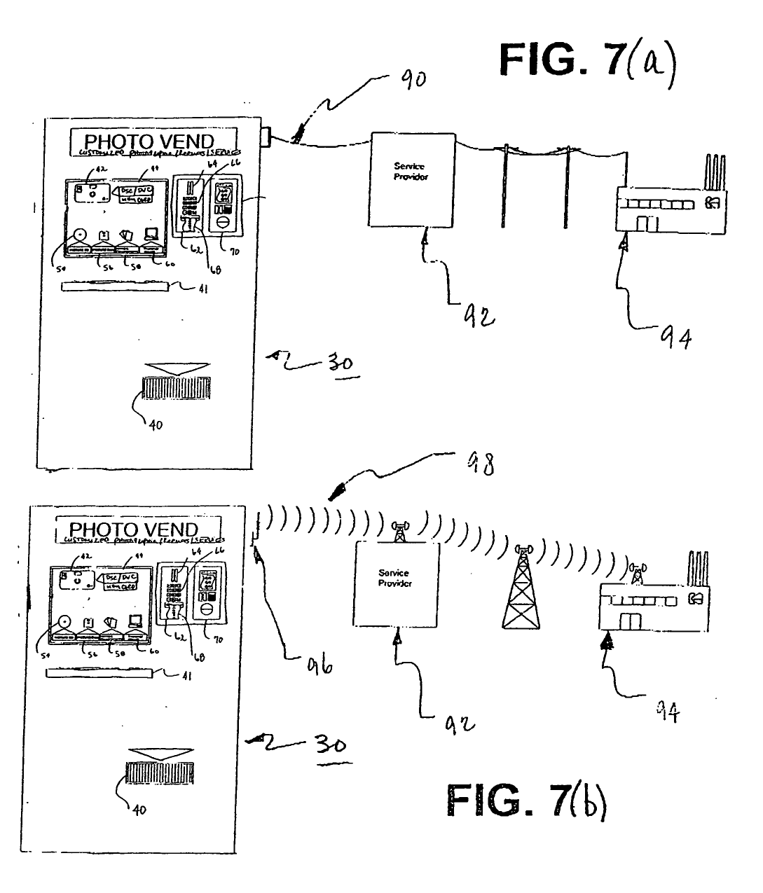

Referring now to FIG. 7(a), kiosk 30 can be networked by means of a communication network 90 to a remote location. The remote location can be a service provider 92, such as an internet service provider or online photofinisher, or a product/service provider 94, such as a wholesale lab, manufacturer, or retailer. Alternatively, as illustrated in FIG. 7(b), kiosk 30 can be configured with a wireless communication system 96 for wireless communication 98 to service provider 92 or product/service provider 94. Custom information collected at the remote location can provide a product and service provider with sales and marketing information, allowing a retailer to produce user profiles.

While kiosk 30 has been disclosed as being configured to dispense a customized imaging product, kiosk 30 can be configured to receive the customized imaging product. That is, when the user has used the customized digital camera 10′ and desires to have the captured digital images subject to further prepaid services or pay on demand services. As such, kiosk 30 can receive customized digital camera 10′ and provide the user with a desired output imaging product and/or service.

In addition, if the use of the customized digital camera is for a predetermined or particular time period for a fee, the user has an interest in returning the customized digital camera. Accordingly, kiosk 30 can be configured to accept the customized digital camera to complete the usage/loan/rental.

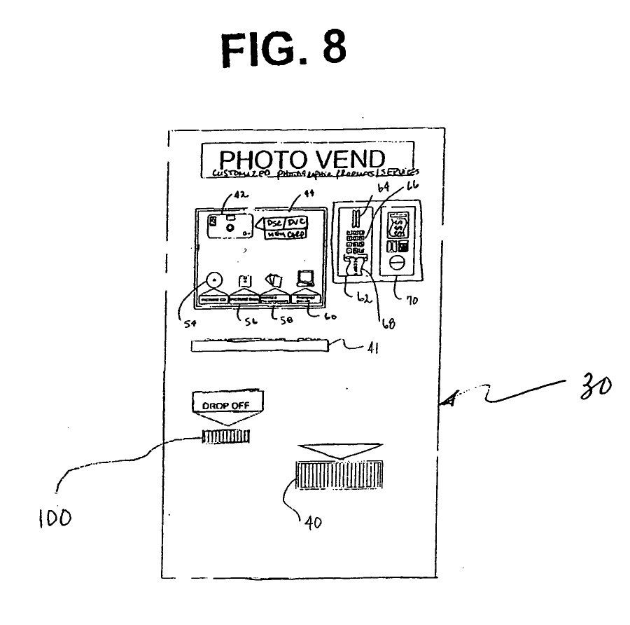

FIG. 8 shows kiosk 30 having a receiving area 100 for receiving customized digital camera 10′, i.e., the customized imaging product. While FIG. 8 shows receiving area 100 as being separate and distinct from delivery area 40, those skilled in the art will recognize that receiving area 100 and delivery area 40 can be configured to be the same area. For ease of discussion, receiving area 100 will be shown as being distinct from delivery area 40.

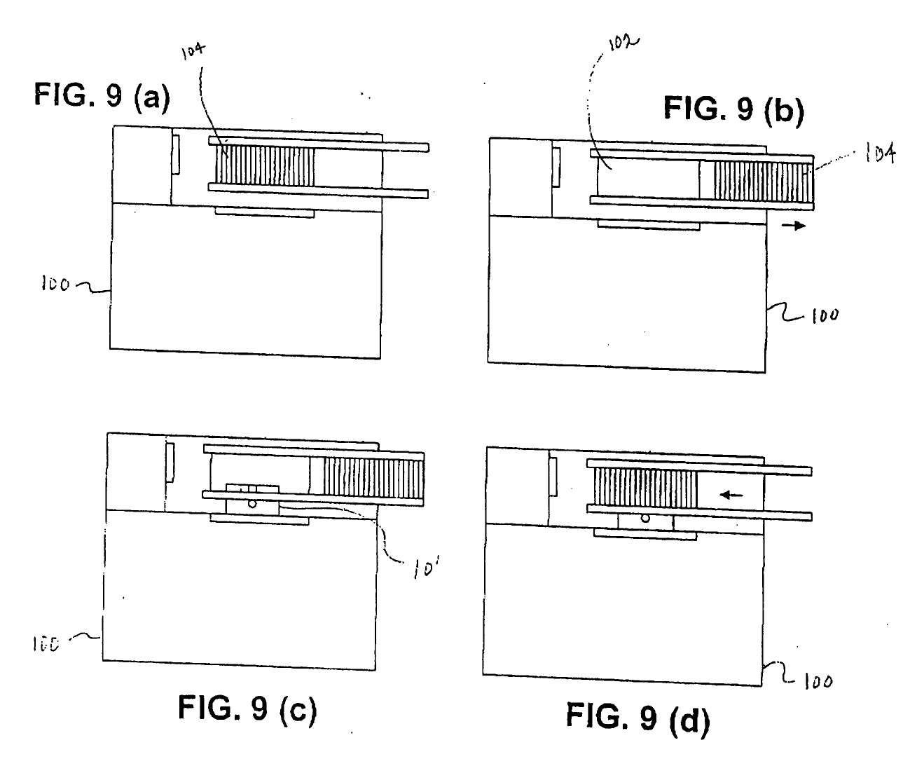

Referring now to FIG. 9(a)-(h), there is shown customized digital camera 10′ being received by kiosk 30. Receiving area 100 comprises an opening 102 having a door or covering 104 to preclude access to opening 102. Initially, covering 104 covers opening 102 to prevent kiosk 30 from receiving camera 10′, as shown in FIG. 9(a), or unauthorized items. Upon activation of kiosk 30 by the user to indicate that customized camera 10′ is to be deposited, covering 104 is moved away from opening 102 to expose receiving area 100, as shown in FIG. 9(b). (It is noted that activation of kiosk 30 can occur at interaction with payment area 38.) The user places customized camera 10′ in receiving area 100 (FIG. 9(c)) and covering 104 moves to cover opening 102 to indicate receipt of customized camera 10′ (FIG. 9(d)).

With door 104 covering opening 102, radio-frequency communication device 80 transmits a radio-frequency field 108 with an appropriate communication signal to access transponder 20 disposed on/within customized camera 10′, as shown in FIG. 9(e). Referring now to FIG. 9(f), the encodements earlier programmed in transponder 20 are transmitted back to communication device 80. If no or incorrect encodements are transmitted to communication device 80, covering 104 can open and a message can be indicated to the user that the item placed in receiving area 100 cannot be accepted/received by kiosk 30. If the encodements transmitted to communication device 80 are acceptable, customized camera 10′ can be accepted by kiosk 30 and placed in a holding area until collected. For example as shown in FIG. 9(g), a door or covering 110 can be moved to expose an opening 112 to a holding area 114 for holding customized imaging products received by kiosk 30. Once customized camera 10′ is moved to holding area 114, covering 110 is moved back into place, thereby covering opening 112, as shown in FIG. 9(h).

Since customized digital camera 10′ is a high valued item, it may be desirable to test the customized digital camera 10′ being returned to verify that it is operational and has not be damaged by the user. Accordingly, when customized digital camera 10′ has been placed in receiving area 100, the camera can be tested. For example, a visual inspection system might inspect for dirt/scratches. Similarly, a digital image of the digital camera 10′ can be captured and transmitted to a remote/central location wherein an operator/technician will view digital camera 10′. Further, digital camera 10′ can be configured to capture a digital image of a test target and the capture image can be analyzed to verify that the digital camera is being returned in working order. Those skilled in the art may know of other automated methods/tests to verify the operation of the digital camera being returned to kiosk 30.

Holding area 114 can comprise a plurality of holding sections, bins, or the like, for example, a section for defective products, a section for imaging products submitted by the user which require processing, and/or a section for imaging products requiring special services.

Holding area 114 can comprise a plurality of areas for pre-sorting of customized cameras 10′ for processing. For example, one of the plurality of pre-sort areas can be designated for customized cameras 10′ requiring an imaging service of prints, while another one of the plurality of pre-sort areas can be designated for customized cameras 10′ requiring a imaging service of Picture CDs.

The encodements transmitted from transponder 20 to communication device 80 can be transmitted to service provider 92 or product/service provider 94 by means of communication network 90 or wireless communication system 96 as aforementioned. In particular situations, it may be desirable to verify that the encodements from transponder 20 correspond or are associated with custom information stored at service provider 92 or products/services provider 94. That is, customized camera 10′ is transported to holding area 114 only upon verification of the custom information. As such, receiving area 100 is responsive to the input means or payment means.

Holding area 114 can comprise a printer or processor for generating a requested output product/service requested by the user using one or more digital images captured using customized digital camera 10′. For example, if kiosk 30 comprises a printer, prints and enlargements can be printed on demand at kiosk 30 when the user interacts with the kiosk. The images to be printed can be transmitted to kiosk 30 using communication network 90,98. As such, the user need not return to the same kiosk from where camera 10′ was originally purchased or where the user dropped off camera 10′ for processing.

Kiosk 30 can further comprise a service area (not shown) for holding the imaging services associated with customized camera 10′ for pick up by the user. That is, if the custom information of customized camera 10′ included an imaging service, for example prints, enlargements, or Picture CD, the user can return to kiosk 30 to collect the imaging services selected and paid for. The services area can be configured as a slot in kiosk 30 having an opening from which the user can collect the imaging services. Still further, services area can be delivery section 40; that is, the services purchased by the user can be delivered to the user by means of delivery section 40. Access to the user's imaging services can be obtained, for example, through the inputting of an access code to kiosk 30 using the input means. Another example for obtaining the services is by the use of a “loyalty card” or credit card comprising an RF tag which is read by kiosk 30 and corresponds the user's services with the user for pick-up.

The services purchased by the user can be delivered in pouches/packages comprising a radio frequency tag, so as to verify the contents and/or intended recipient.

Accordingly, the present invention provides a system for providing an imaging product and service. The system includes input means for providing custom information; means for associating the custom information with the imaging product to produce a customized imaging product; a delivery section for dispensing the customized imaging product; a receiving area for receiving the customized imaging product; means for identifying the customized imaging product; means for testing the customized imaging product, and means for associating the custom information with the customized imaging product to provide the imaging service.

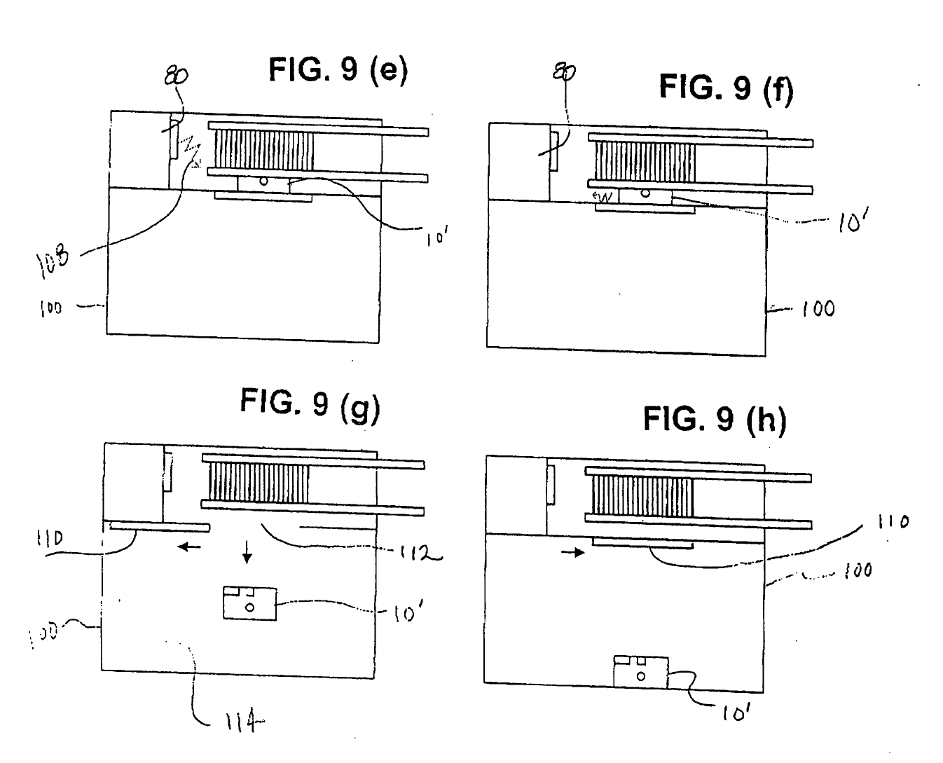

FIG. 10 provides a flow diagram of a method in accordance with the present invention for providing the high value customized imaging product disclosed above. At step 200, custom information is provided to a system related to a high value imaging product and/or services. Using the system, the imaging product is modified using the custom information to produce a customized imaging product (step 202). The customized imaging product is tested (step 204) and agreement for its use (including payment) is provided by the user (step 206). After which, the customized imaging product is dispensed from the system (step 208) to a user. Once used by the user, the user returns the customized imaging product to the system, whereby the customized imaging product is received at the system (step 210). The system identifies the customized imaging product which has been received (step 212) and can test the customized imaging product to ensure that it is received in working order, whereby the custom information is associated with the customized imaging product to provide the imaging service associated with the customized imaging product (step 214).

Customized digital camera 10′ could be configured such that the digital data of the captured digital images is encrypted, thereby requiring the user to return the customized digital camera 10′ to kiosk 30 in order to access the captured digital images by using a service offered by kiosk 30, i.e., print, upload, transfer, CD, and the like. Alternatively, the user could pay an additional fee in order to obtain the encryption code to access the captured digital images from a location other than kiosk 30.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

The invention has been described in detail with particular reference to certain preferred embodiments thereof, but it will be understood that variations and modifications can be effected within the spirit and scope of the invention.

### PARTS LIST

10 imaging device/product; digital camera
10′ customized imaging device/product' customized digital camera
12 body
14 lens
16 slot/opening/aperture
18 digital data; memory card
20 radio-frequency identification transponder
22 field; communication signal
26 communication unit; receiver
30 dispensing unit; kiosk; vending machine
32 body
34 display side
36 selection area
38 payment area
40 delivery area
41 input device; keyboard
42 icon; digital camera
44 textual information; features digital camera
54 icon; Picture CD
56 icon; Picture Disk
58 icon; prints/enlargements
60 icon; Photonet On-line; Ofoto Inc.; on-line service provider
62 payment mechanism; card reader
64 slot
66 keypad
68 receipt area
70 payment mechanism; cash
72 product area
74 customization area
76 hopper
80 radio frequency communication device
81 door; covering
82 door/covering
84 holding area
90 communication network
92 service provider
94 product/service provider
96 wireless communication system
98 wireless communication
100 receiving area
102 opening
104 door/covering
108 radio-frequency field
110 door/covering
112 opening

1. A system for providing a high value customized imaging device, comprising:
input means for providing custom information;
means for customizing a high value imaging device to generate the high value customized imaging device in accordance with the custom information;
a test section for validating the readiness for use of the high value customized imaging device;
a means for securing agreement to the terms of use of the high value customized imaging device; and
a delivery section for dispensing the high value customized imaging device.

2. A system for providing an imaging product and service, comprising:
input means for providing custom information;
means for associating the custom information with the imaging product to generate a customized imaging product;
a delivery section for dispensing the customized imaging product;
a receiving area for receiving the customized imaging product;
means for testing the customized imaging product;
means for identifying the customized imaging product; and
means for associating the custom information with the customized imaging product to provide the imaging service.

3. A method for providing an imaging product and service, comprising the steps of:
providing the imaging product;
receiving custom information;
modifying the imaging product using the custom information to generate a customized imaging product;
testing the customized imaging product;
dispensing the customized imaging product;
receiving the customized imaging product;
identifying the customized imaging product;
verifying the operability of the identified customized imaging product; and
associating the custom information with the customized imaging product to provide the imaging service.

4. The method of claim 3, wherein the customized imaging product is received at a first location, and the method further comprises the step of providing the imaging service at a second location remote from the first location.

5. The method of claim 3 wherein the customized imaging product is a digital camera adapted to capture digital data representative of digital images, and the method further comprises the step of encrypting the digital data.
